(19) United States
(12) Patent Application Publication
(10) Pub. No.: US 2020/0355241 A1
(43) Pub. Date: Nov. 12, 2020

(54) INTEGRATED DROP WIRE CLAMP AND METHOD OF USE

(71) Applicant: Allied Bolt, Inc., Lake Success, NY (US)

(72) Inventor: Glen K. Malin, Lake Success, NY (US)

(73) Assignee: Allied Bolt, Inc., Lake Success, NY (US)

(21) Appl. No.: 16/405,584

(22) Filed: May 7, 2019

(51) Int. Cl. F16G 11/04; F16G 11/02

(52) U.S. Cl. CPC F16G 11/048; F16G 11/02

(57) ABSTRACT

Integrated one-piece drop wire clamps and methods to hold a cable therein. The drop wire clamps comprising a shell with a base portion having a first end and a second end with a longitudinal axis therebetween and opposing side walls extending from the base portion along edges thereof to define a channel therebetween. The side walls are angled with respect to each other and separated by a first distance proximate the first end and a second distance proximate the second end, the second distance smaller than the first distance. The drop wire clamps further include opposing slide wedges disposed within the channel and moveable between a first position and a second position. The side walls bias the slide wedges towards a center of the channel as the slide wedges move from the first position to the second position. Method of securing cable in drop wire clamps also provided.

### FIELD OF THE DISCLOSED SUBJECT MATTER

The presently disclosed subject matter generally relates to drop wire clamps and methods to secure a wire or cable to a structure with a drop wire clamp.

### BACKGROUND OF THE DISCLOSED SUBJECT MATTER

Drop wire clamps can be used to secure a cable, intermediate at its ends, to a span clamp, pole attachment, or house attachment. Various drop wire clamps have been developed. Examples of known clamps are provided in U.S. Pat. Nos. 6,581,251 and 8,517,317, the disclosures of which are hereby incorporated by reference.

Some drop wire clamps, however, have deficiencies. For example, certain clamps require an operator to manipulate two or more separate pieces in order to secure a cable within the clamp. Operators working at height and/or with gloves may be prone to dropping one or more pieces of a clamp, which can increase the time needed to securely clamp a cable and can cause an operator to install a clamp incorrectly, for example, by not using all the pieces to properly assemble the clamp.

Certain clamps are produced from plastic in order to reduce part weight and manufacturing costs. However, such clamps often are not capable of adequately securing drop cables. For example, plastic protrusions designed to grip the cable jacket can dull or flake off over time and when exposed to harsh environmental factors.

Additionally, certain clamping systems include a slot that remains open when the clamp is tensioned, or secured to a cable. Cables can detach from such clamps and fall thru the open slots as the clamp's grip on the cable loosens over a time period. There exists a need for an improved clamp that overcomes at least the above-identified issues.

### SUMMARY OF THE DISCLOSED SUBJECT MATTER

The purpose and advantages of the disclosed subject matter will be set forth in and apparent from the description that follows, as well as will be learned by practice of the disclosed subject matter. Additional advantages of the disclosed subject matter will be realized and attained by the methods and systems particularly pointed out in the written description and claims hereof, as well as from the appended drawings.

The disclosed subject matter provides an integrated one-piece drop wire clamp to hold a cable therein. In one example, the integrated drop wire clamp generally includes a shell having a base portion. The base portion has a first end and a second end with a longitudinal axis therebetween. The shell further includes opposing side walls extending from the base portion along edges thereof to define a channel therebetween. The side walls can be angled with respect to each other and separated by a first distance proximate the first end and a second distance proximate the second end. The second distance can be smaller than the first distance.

The integrated drop wire clamp can further include opposing slide wedges disposed within the channel and moveable between a first position and a second position. The side walls of the shell can bias the slide wedges towards a center of the channel as the slide wedges move from the first position to the second position.

According to a further aspect of the disclosed subject matter, methods of securing a cable in a drop wire clamp are provided. In an exemplary embodiment, a method generally includes providing an integrated drop wire clamp having a shell with a base portion. The base portion has a first end and a second end with a longitudinal axis therebetween. The shell further includes opposing side walls extending from the base portion along edges thereof to define a channel therebetween. The side walls are angled with respect to each other and separated by a first distance proximate the first end and a second distance proximate the second end. The second distance is smaller than the first distance.

The method can further include inserting a cable within the channel with the slide wedges in the first position and moving the slide wedges from the first position to the second position to secure the cable therebetween.

According to a further aspect of the disclosed subject matter, an integrated one-piece drop wire clamp as described above is provided. The opposing slide wedges of the drop wire clamp are formed from a non-metallic material and include a metallic shim molded therein.

It is to be understood that both the foregoing general description and the following detailed description are exemplary and are intended to provide further explanation of the disclosed subject matter claimed.

The accompanying drawings, which are incorporated in and constitute part of this specification, are included to illustrate and provide a further understanding of the containers and methods of the disclosed subject matter. Together with the description, the drawings serve to explain the principles of the disclosed subject matter.

### BRIEF DESCRIPTION OF THE DRAWINGS

The subject matter of the application will be more readily understood from the following detailed description when read in conjunction with the accompanying drawings, in which:

FIG. 1 is a front perspective view of an integrated drop wire clamp with the opposing slide wedges in a first position and a cable disposed in the channel, in accordance with the disclosed subject matter.

FIG. 2A is a front perspective view of the shell of the integrated drop wire clamp of FIG. 1, with the opposing slide wedges removed for purpose of illustration and explanation.

FIG. 2B is a front view of the shell of FIG. 2A.

FIG. 3A is a rear perspective view of a slide wedge of the integrated drop wire clamp of FIG. 1, shown in isolation for purpose of illustration and explanation.

FIG. 3B is side perspective view of the slide wedge of FIG. 3A.

FIG. 4A is a rear perspective view of the other slide wedge of the integrated drop wire clamp of FIG. 1 shown in isolation for purpose of illustration and explanation.

FIG. 4B is a front view of the opposing slide wedge of FIG. 4A.

FIG. 4C is a bottom perspective view of the opposing slide wedge of FIG. 4A.

FIG. 5A is a top view of the integrated drop wire clamp of FIG. 1 with the opposing slide wedges in a first position.

FIG. 5B is a top view of the integrated drop wire clamp of FIG. 1 with the opposing slide wedges in a second position.

### DETAILED DESCRIPTION

Reference will now be made in detail to the various embodiments of the disclosed subject matter, embodiments of which are illustrated in the accompanying drawings. The structure and corresponding method of operation of the disclosed subject matter will be described in conjunction with the detailed description of the system.

The apparatus and methods presented herein can be used for securing a variety of cable sizes to a structure. The disclosed subject matter is suited for securing communication cables, including fiber optic cables, to structures such as buildings.

The integrated drop wire clamps and methods of the disclosed subject matter provide performance characteristics not achieved by certain conventional drop wire clamps. For purpose of understanding and not limitation, the metallic abrading surfaces can improve the effectiveness of the integrated drop wire clamp. As described above, plastic protrusions can dull and wear over time. Metallic abrading surfaces can provide a more permanent and durable hold when a cable is secured within the clamp. Moreover, metal abrading surface can engage tough cable jacketing, such as that used for fiber optic cabling, better than plastic protrusions or the like. Additionally, embedding the metallic material within a non-metallic material, such as plastic or the like, can result in slide wedges with light part weight and reduced overall part cost while maintaining the advantages associated with a metallic abrading surface.

Substantially sealing the channel between the slide wedges can further improve the performance of the drop wire clamps by preventing cables from detaching laterally from the drop wire clamp, for example, by falling out of the channel through the open space between the slide wedges as the clamp's grip on the cable loosens over time. For example and not limitation, the slide wedge flange can bound a cable within the channel as described above, which can prevent the cable from falling out of the channel.

Additionally, the integrated nature of the drop wire clamps in accordance with the disclosed subject matter can provide a user with a single piece to install. For example, and as described above, the drop wire clamps can include various features to prevent the slide wedges and/or bail wire from becoming separated from the shell. Having fewer pieces, e.g., a single piece, to install can be simpler for users in the field. For example, users often wear heavy field gloves, which can make it challenging to install drop wire clamps including one or more separate pieces that must be assembled in the field.

Integrated drop wire clamps according to the disclosed subject matter can more securely grip and secure cables to various structures and be installed more easily when compared to conventional drop wire clamps and the like.

In accordance with the disclosed subject matter herein, the integrated drop wire clamp generally includes a shell having a base portion. The base portion has a first end and a second end with a longitudinal axis therebetween. The shell further includes opposing side walls extending from the base portion along edges thereof to define a channel therebetween. The side walls are angled with respect to each other and separated by a first distance proximate the first end and a second distance proximate the second end. The second distance is smaller than the first distance. For example, the second distance can be between approximately 20 percent to approximately 65 percent smaller than the first distance depending on the desired performance characteristics of the drop wire clamp.

The integrated drop wire clamp further includes opposing slide wedges disposed within the channel and moveable between a first position and a second position. The side walls of the shell bias, or force, the slide wedges towards a center of the channel as the slide wedges move from the first position to the second position.

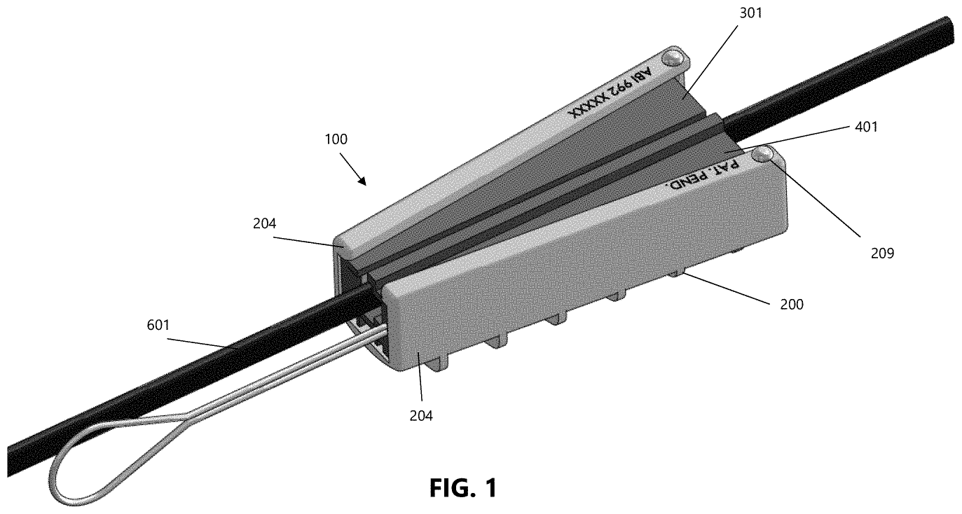

The accompanying figures, where like reference numerals refer to identical or functionally similar elements throughout the separate views, serve to further illustrate various embodiments and to explain various principles and advantages all in accordance with the disclosed subject matter. For purpose of explanation and illustration, and not limitation, an embodiment of an integrated drop wire clamp in accordance with the disclosed subject matter is shown in FIGS. 1-5B. The integrated drop wire clamp of the disclosed subject matter is suitable for securing a wide range of cables to various structures.

An embodiment of an integrated drop wire clamp 100 is depicted in FIG. 1. The clamp includes a shell 200 with opposing side walls 204 defining a channel therebetween. As described further herein, the side walls 204 are angled with respect to each other. The integrated drop wire clamp 100 further includes opposing slide wedges 301 and 401 disposed within the channel. As described further herein, the slide wedges 301 are moveable between a first position and a second position, and the side walls 204 bias the slide wedges 301 and 401 towards a center of the channel 205 as the slide wedges 301 and 401 move from the first position to the second position.

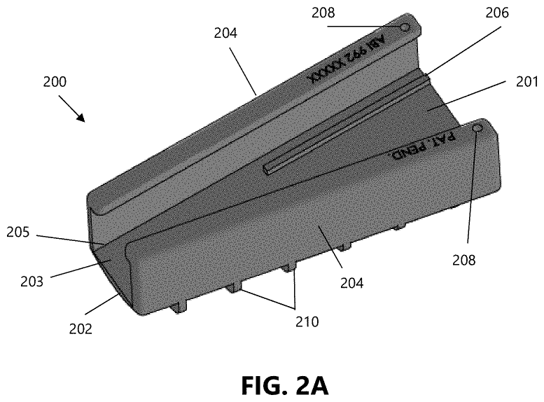

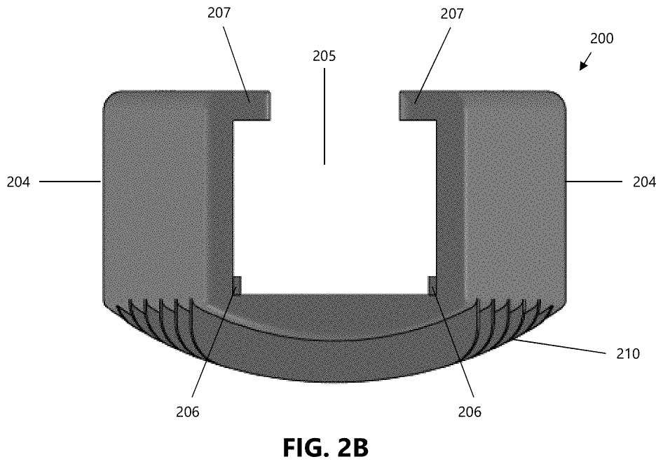

With reference to FIG. 2A and FIG. 2B, the shell 200 includes a base portion 203. The base portion 203 includes a first end 201 and a second end 202. As described above, the shell 200 further includes opposing side walls 204 extending from the base portion 203 along edges thereof to define a channel 205 therebetween that can receive the slide wedges 301, 401. The side walls 204 are angled with respect to each other. The side walls 204 can be angled at a suitable degree such as ranging between approximately 5 degrees and approximately 45 degrees. The side walls 204 are separated by a first distance proximate the first end 201 and separated by a second distance proximate the second end 202.

In one embodiment, the first distance is approximately 1.8 inches and the second distance is approximately 1.2 inches, but any suitable distance is contemplated herein such as for purposes of example the first distance can be between approximately 2.4 inches and approximately 1.3 inches, and the second distance can be between approximately 1.6 inches and approximately 0.85 inches. The second distance is smaller than the first distance to facilitate a guide structure for the slide wedges 301, 401. The side walls 204 can define a substantially V-shape in plan view. As further embodied herein, the shell 200 can include a plurality of ribs 210 extending from the base portion 203 opposite the channel 205. Ribs 210 can provide finger areas for a user to insert fingers therein for ease of use and installation of the drop wire clamp 100.

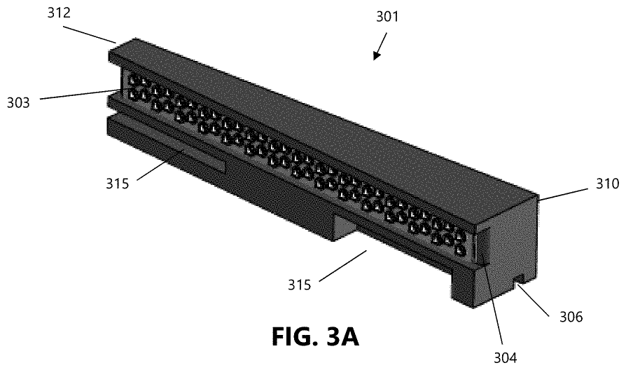

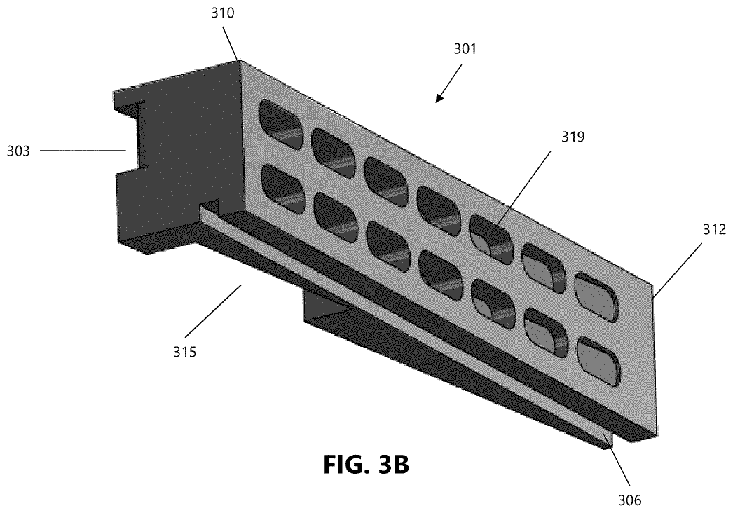

As described further herein, the integrated drop wire clamp 100 includes slide wedges 301 and 401, which are moveable between a first position and a second position. For purpose of example and not limitation, the shell 200 can include one or more features which can be used to guide movement of the slide wedges 301 and 401 from the first position to the second position and/or to secure the slide wedges 301 and 401 within the shell 200. For example, and as embodied herein, the base portion 203 can include opposing rails 206 extending along at least a portion of the base portion 203. As shown in FIG. 3B, the slide wedges 301 and 401 can include corresponding guide channels 306 and 406 configured to complement and receive a respective opposing rail 206, as described further herein. The opposing rails 206 can slidably engage with the guide channels 306 and 406 of the slide wedges 301 and 401 to guide the movement of the slide wedges 301 and 401 from the first position to the second position, as further described herein.

As further embodied herein, the side walls 204 can each include a flange 207 extending toward the center of the channel 205 from an outer portion of each side wall 204. The flanges 2017, side walls 204, and base 203 collectively further define the channel 205 for receiving the slide wedges 301, 401. The slide wedges 301 and 401 can be positioned between the base portion 203 and a respective flange 207 of each respective sidewall 204. For purpose of example, and as further embodied herein, each side wall 204 can include an aperture 208 configured to cooperate with and receive a lock pin 209. The lock pins 209 can engage with an end of each slide wedge when the slide wedges are in the first position, as described further herein. The opposing rails 206, flanges 207, and lock pins 209 can secure the slide wedges 301 and 401 within the shell 200.

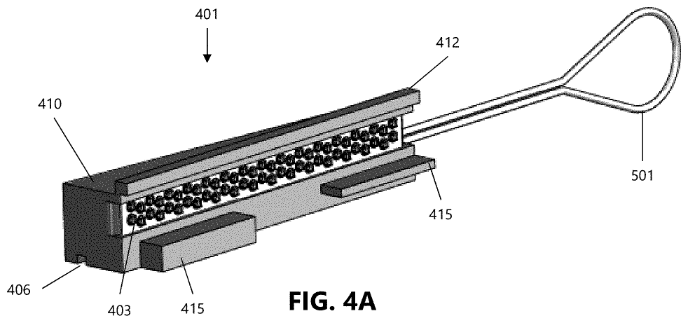

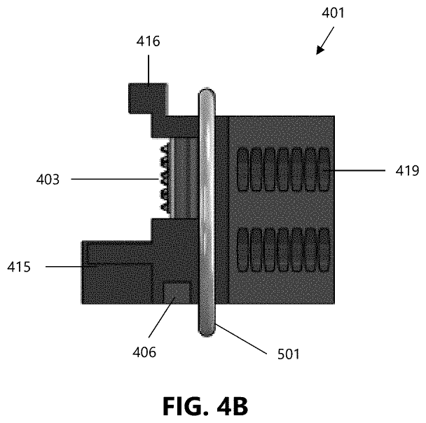

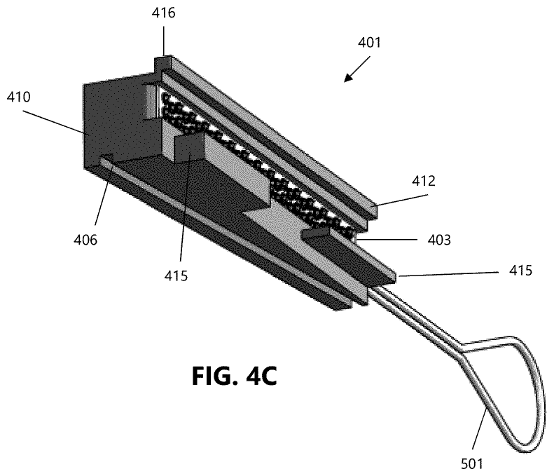

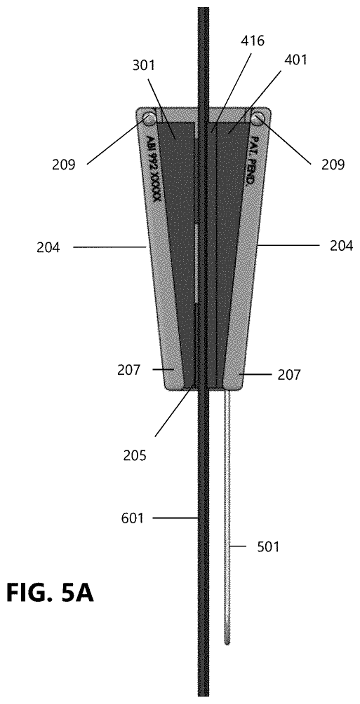

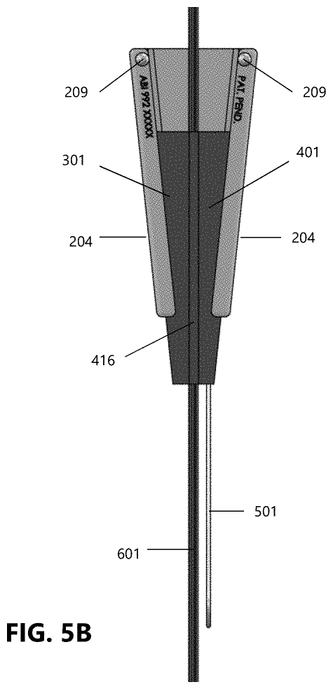

Slide wedges in accordance with the disclosed subject matter are depicted in FIG. 4A-FIG. 5C apart from the shell 200 for purpose of example and explanation. As described above, the slide wedges 301 and 401 are disposed within the channel 205 and moveable between a first position and a second position. With reference to the slide wedge 301 depicted in FIG. 4A-FIG. 4B, the slide wedge 301 can have a first end 310 and a second end 312. The first end 310 can be disposed proximate the first end 201 of the base portion 203, and the second end 312 can be disposed proximate the second end of the base portion 203. For purpose of example, and as embodied herein, the slide wedge 301 can include a metallic abrading surface 303. The metallic abrading surface can be configured to engage cable jacketing and grip a cable with the slide wedges in the second position, as described further herein.

For example, the metal abrading surface 303 can include multi-edged gripping teeth which can engage cable jacketing to grip a cable. The configuration of the abrading surface 303 can be selected based on the desired performance characteristics of the integrated drop wire clamp and the types of cables being secured or gripped. For example, the metal abrading surface 303 can include longer teeth or perforations to grip heavier cables with thicker jacketing. The metal abrading surface can be made of any suitable metallic material, and can include, for example, aluminum and/or copper. For purpose of example and as embodied herein, the metallic abrading surface can include stainless steel.

Slide wedge 301 can be made from suitable material. For purpose of example, slide wedge 301 can be made from a non-metallic material, such as plastic, and a metallic member 304 can be molded therein. The metallic member 304 can define the metallic abrading surface 303. Slide wedge 301 can be molded with metallic member 304 therein using, for example, plastic injection molding techniques, which are well known in the art. The metallic member 304 and the metallic abrading surface 303 can be embedded within the non-metallic slide wedge. For purpose of example, and as embodied herein, the metallic member 304 can be a stamped metallic shim.

In accordance with one aspect of the disclosed subject matter, the slide wedges are formed from a non-metallic material, and each slide wedge includes a metallic shim molded therein. The metallic member 304 can be any suitable metallic material, and can include, for example, aluminum, copper, and as embodied herein, stainless steel. As described above, molding a metallic member within the non-metallic slide wedge can result in slide wedges with light part weight and reduced overall cost. For purpose of example, and as embodied herein, slide wedge 301 can include cutouts 319 opposite the metallic abrading surface 303, which can provide part weight savings. As described further herein, the use of a metallic abrading surface embedded within and monolithic with the wedges can allow the integrated drop wire clamp 100 to better grip and secure cables therein.

As described above, the slide wedge 301 can include a guide channel 306 configured to receive a respective rail 206 defined in the base portion 203. The rail 206 of the base portion 203 can slidably engage with the guide channel 306 of the slide wedge 301 to guide movement of the slide wedge between the first position and the second position.

With reference to the slide wedge 401 depicted in FIG. 4A-FIG. 4C, the slide wedge 401 can have a first end 410 and a second end 412. The first end 410 can be disposed proximate the first end 201 of the base portion 203, and the second end 412 can be disposed proximate the second end of the base portion 203. The slide wedge 401 can include the features described above with respect to slide wedge 301. For example, and as embodied herein, the slide wedge 401 can include a guide channel 406 configured to receive a respective rail 206 defined in the base portion 203. Additionally, the slide wedge 401 can include the metallic abrading surface 403 and cutouts 419 opposite the metallic abrading surface 403.

For purpose of example and not limitation, the slide wedges 301 and 401 can include one or more features which can coordinate movement of the slide wedges 301 and 401 as the slide wedges move from the first position to the second position. The slide wedge 401 can include one or more interlocking tabs 415 and the slide wedge 301 can include a corresponding number of notches 315 configured to receive the one or more interlocking tabs 415, or vice versa. For purpose of example and not limitation, and as embodied herein, the slide wedge 401 can include two interlocking tabs 415 and the slide wedge 301 can include two notches 315. The interlocking tabs 415 can engage with the notches 315 to facilitate the slide wedges 301 and 401 moving together from the first position to the second position, as described further herein.

Additionally, or alternatively, at least one of the slide wedges 301 and 401 can include a slide wedge flange. For purpose of example, and as embodied herein, the slide wedge 401 can include flange 416 extending from an outer portion of slide wedge 401 towards the center of channel 205. The flange 416 can be configured to extend across the channel 205 from slide wedge 401 to slide wedge 301 with the channel 205 bounded therebetween when the slide wedges 301 and 401 are in the second position.

The drop wire clamp 100 can further include a tail wire 501. The tail wire can be used, for example, to secure the drop wire clamp 100 to a structure, such as a pole or house. For purpose of example, the tail wire 501 can extend from an end of at least one of the slide wedges 301 and 401. An end of the tail wire 501 can be monolithic with slide wedge 401 and the tail wire can extend from the second end 412 of slide wedge 401 to define a loop. For purpose of example, the slide wedge 401 can be molded with tail wire 501 therein using injection molding techniques known in the art. Additionally, or alternatively, the tail wire 501 can extend between the slide wedges 401 and 301. For example, one end of the tail wire 501 can be monolithic with slide wedge 401 and the other end of the tail wire 501 can be monolithic with slide wedge 301.

The operation of the integrated drop wire clamp 100 will now be described by way of an example. With reference to FIG. 5A, the integrated drop wire clamp is depicted with the slide wedges 301 and 401 in a first position. When the slide wedges 301 and 401 are in the first position, a channel is created between the slide wedges 301 and 401. A cable or wire can be inserted into the channel between the slide wedges 301 and 401 with the slide wedges in the first position.

The slide wedges 301 and 401 can be positioned between the base portion 203 and a respective flange 207 of the respective side wall 204. The guide channels 306 and 406 of the slide wedges 301 and 401 can be in engagement with the rails 206 of the base portion 203. As described above, the lock pins 209 can engage with the respective first ends of each slide wedge when the slide wedges are in the first position. The flanges 207, rails 206, and lock pins 209 of the shell 200 can interact with the respective portions of the slide wedges 301 and 401 as described above to retain the slide wedges 301 and 401 within the channel 205 and prevent the slide wedges 301 and 401 from becoming dislodged or sliding out of the channel 205. For purpose of example, the slide wedges 301 and 401 can be inserted within the channel between the base portion 203 and a respective flange 207 of the respective side wall 204. Lock pins 209 can then be inserted through apertures 208 to retain the slide wedges 301 and 401 within the shell 200. For purpose of example, lock pins 209 can include rivets. With the slide wedges 301 and 401 retained in the shell 200, the integrated drop wire clamp 100 can be installed as a single piece, as described further herein.

With reference to FIG. 5B, the integrated drop wire clamp 100 is depicted with the slide wedges 301 and 401 in a second position. As embodied herein, the guide channels 306 and 406 of the slide wedges 301 and 401 can be in slidable engagement with the rails 206 of the base portion 203, and the rails 206 can guide the movement of the slide wedges within the shell 200 as the slide wedges 301 and 401 move from the first position to the second position. As described above, the side walls 204 are angled with respect to each other and separated by a first distance proximate the first end 201 and a second distance proximate the second end 202, the second distance smaller than the first distance. The side walls bias the slide wedges towards the center of the channel 205 as the slide wedges move from the first position to the second position.

For purpose of example, and as embodied herein, the integrated drop wire clamp 100 can be configured to receive at least a portion of a cable 601 in the channel 205 with the slide wedges 301 and 401 in the first position. For purpose of example, the portion of the cable 601 received in the channel 205 can be a mid-length portion of the cable. As such, a user need not thread an end of the cable into the integrated drop wire clamp 100, as the user can simply insert a mid-length portion of the cable 601 into the channel 205 with the slide wedges in the first position. The integrated drop wire clamp 100 can secure the at least a portion of the cable 601 within the channel 205 between the slide wedges 301 and 401 with the slide wedges in the second position. The cable 601 can be any suitable cable. For purpose of example and not limitation, the cable 601 can be a SST-Drop cable as commercially available from Corning Optical Communications.

As embodied herein, the metal abrading surfaces 303 and 403 of the slide wedges 301 and 401 can engage cable jacketing and grip a cable with the slide wedges in the second position. For example, as the slide wedges 301 and 401 move from the first position to the second position, the side walls 204 bias the slide wedges towards the center of the channel 205. As the slide wedges 301 and 401 are biased towards the center of the channel 205, the metal abrading surface can contact a cable disposed in the channel and the biasing force can cause the abrading surface to engage the cable jacketing of the cable to grip the cable within the channel 205.

As further embodied herein, and as described above, the slide wedge flange 416 can extend across the channel 205 from slide wedge 401 to slide wedge 301 with the channel 205 bounded therebetween when the slide wedges 301 and 401 are in the second position. In this manner, the channel space can be substantially sealed when the slide wedges 301 and 401 are in the second position, and the risk of the cable falling out of the integrated drop wire clamp can be reduced.

In accordance with another aspect of the disclosed subject matter, a method of securing a cable in a drop wire clamp is provided. The method generally includes providing an integrated drop wire clamp as described above. The method further includes inserting a cable within the channel 205 with the slide wedges in the first position and moving the slide wedges 301 and 401 from the first position to the second position to secure the cable therebetween.

For purpose of example, and as embodied herein, the integrated drop wire clamp can further include a tail wire 501 extending from at least one of the slide wedges 301 and 401, and moving the slide wedges from the first position to the second position can include pulling the tail wire 501 in a first direction. As described above the slide wedge 401 can include an interlocking tab 415 and the slide wedge 301 can include a corresponding notch 315 configured to receive the interlocking tab 415. Pulling the tail wire 501 in the first direction can move both slide wedges from the first position to the second position. For example, the force applied to slide wedge 401 through the tail wire 501 can be transferred to slide wedge 301 by the engagement of the interlocking tab 415 and notch 315.

In addition to the specific embodiments claimed below, the disclosed subject matter is also directed to other embodiments having any other possible combination of the dependent features claimed below and those disclosed above. As such, the particular features presented in the dependent claims and disclosed above can be combined with each other in other manners within the scope of the disclosed subject matter such that the disclosed subject matter should be recognized as also specifically directed to other embodiments having any other possible combinations. Thus, the foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the method and system of the disclosed subject matter without departing from the spirit or scope of the disclosed subject matter. Thus, it is intended that the disclosed subject matter include modifications and variations that are within the scope of the appended claims and their equivalents.

1. An integrated one-piece drop wire clamp to hold a cable therein comprising:
a shell including:
a base portion having a first end and a second end with a longitudinal axis therebetween, and
opposing side walls extending from the base portion along edges thereof to define a channel therebetween, the side walls angled with respect to each other and separated by a first distance proximate the first end and a second distance proximate the second end, the second distance smaller than the first distance; and
opposing slide wedges disposed within the channel and moveable between a first position and a second position, wherein the side walls bias the slide wedges towards a center of the channel as the slide wedges move from the first position to the second position.

2. The integrated drop wire clamp of claim 1, wherein the base portion includes opposing rails extending along at least a portion of the base portion and the slide wedges each including a guide channel configured to receive a respective opposing rail.

3. The integrated drop wire clamp of claim 2, wherein the opposing rails of the base portion slidably engage with the guide channels of the slide wedges to guide movement of the slide wedges from the first position to the second position.

4. The integrated drop wire clamp of claim 1, wherein side wall includes a flange extending toward the center of the channel from an outer portion of each side wall.

5. The integrated drop wire clamp of claim 4, wherein the slide wedges are positioned between the base portion and a respective flange of the side walls.

6. The integrated drop wire clamp of claim 1, wherein each side wall includes a lock pin, wherein each lock pin engages with an end of each slide wedge when the slide wedges are in the first position to retain the slide wedges in the channel.

7. The integrated drop wire clamp of claim 1, wherein each slide wedge includes a metallic abrading surface.

8. The integrated drop wire clamp of claim 1, wherein the wedges comprise a non-metallic material having a metallic member molded therein.

9. The integrated drop wire clamp of claim 8, wherein each metallic member includes an abrading surface configured to engage cable jacketing and grip a cable with the slide wedges in the second position.

10. The integrated drop wire clamp of claim 1, wherein a first slide wedge includes at least one interlocking tab and a second slide wedge includes at least one notch configured to receive the at least one interlocking tab.

11. The integrated drop wire clamp of claim 1, wherein at least one of the slide wedges includes a slide wedge flange extending from an outer portion of the at least one slide wedge towards the center of the channel, the slide wedge flange configured to extend across the channel from the at least one slide wedge to the other slide wedge with the channel bounded therebetween when the slide wedges are in the second position.

12. The integrated drop wire clamp of claim 1, further comprising a tail wire extending from an end of at least one of the slide wedges, wherein an end of the tail wire is monolithic with the a least one of the slide wedges.

13. The integrated drop wire clamp of claim 12, wherein the tail wire extends between the end of the at least one slide wedge to an end of the other slide wedge.

14. The integrated drop wire clamp of claim 1, wherein the clamp is configured to receive at least a portion of a cable in the channel with the slide wedges in the first position and to secure the at least a portion of the cable in the channel between the slide wedges with the slide wedges in the second position.

15. The integrated drop wire clamp of claim 14, wherein the at least a portion of the cable is a mid-length portion of the cable.

16. A method of securing a cable in a drop wire clamp comprising:
providing an integrated drop wire clamp having:
a shell including:
a base portion having a first end and a second end with a longitudinal axis therebetween, and
opposing side walls extending from the base portion along edges thereof to define a channel therebetween, the side walls angled with respect to each other and separated by a first distance proximate the first end and a second distance proximate the second end, the second distance smaller than the first distance; and
opposing slide wedges disposed within the channel and moveable between a first and a second position, wherein the side walls bias the slide wedges towards a center of the channel as the slide wedges move from the first position to the second position; and
inserting a cable within the channel with the slide wedges in the first position; and
moving the slide wedges from the first position to the second position to secure the cable therebetween.

17. The method of claim 16, wherein the integrated drop wire clamp further includes a tail wire extending from at least one slide wedge, and wherein moving the slide wedges from the first position to the second position includes pulling the tail wire in a first direction.

18. The method of claim 17, wherein one of the slide wedges includes at least one interlocking tab and the other slide wedge includes a least one notch configured to receive the at least one interlocking tab; and wherein pulling the tail wire moves both slide wedges from the first position to the second position.

19. The method of claim 18, wherein inserting the cable within the channel includes inserting a mid-length of the cable, and wherein at least one of the slide wedges includes a slide wedge flange extending from an outer portion of the at least one slide wedge towards the center of the channel, wherein the slide wedge flange extends across the channel from the at least one slide wedge to the other slide wedge with the cable bounded therebetween when the slide wedges are in the second position.

20. An integrated one-piece drop wire clamp to hold a cable therein comprising:
a shell including:
a base portion having a first end and a second end with a longitudinal axis therebetween, and
opposing side walls extending from the base portion along edges thereof to define a channel therebetween, the side walls angled with respect to each other and separated by a first distance proximate the first end and a second distance proximate the second end, the second distance smaller than the first distance; and
opposing slide wedges disposed within the channel and moveable between a first position and a second position, the opposing slide wedges comprising a non-metallic material and including a metallic shim molded therein,
wherein the side walls bias the slide wedges towards a center of the channel as the slide wedges move from the first position to the second position.
